(19) United States
(12) Patent Application Publication
(10) Pub. No.: US 2005/0250900 A1
(43) Pub. Date: Nov. 10, 2005

(54) Adhesive compositions for bonding lignocellulosic materials, bonding methods and apparatus, and bonded articles

(76) Inventor: John I. Stofko, Beaverton, OR (US)

Correspondence Address: KLARQUIST SPARKMAN, LLP, 121 SW SALMON STREET, SUITE 1600, PORTLAND, OR, 97204, US

(21) Appl. No.: 10/516,239

(22) PCT Filed: May 28, 2003
(86) PCT No.: PCT/US03/17000

§ 371 Date: Nov. 29, 2004

Related U.S. Application Data
(60) Provisional application No. 60/383,698, filed on May 29, 2002.

(51) Int. Cl. C08K 3/00

(52) U.S. Cl. 524/594

(57) ABSTRACT

New adhesives for bonding lignocellulosic material such as wood and wood products include a liquid adhesive solution and a predetermined quantity of extender. One type of extender is an inorganic extender such as earth soil powder, which can be used to form an extended adhesive having a higher viscosity, which may have a liquid state, a solid state or an intermediate state. Another type of extender is an organic extender containing starch, which can be used to form an adhesive having a high viscosity. The new adhesives can be formulated to provide at least comparable bonding strength but are cheaper to use than conventional liquid adhesives in making plywood, fiber board, oriented strand board and other engineered panels and wood products.

### RELATED APPLICATION

This application claims the benefit of prior U.S. Patent Application No. 60/383,698, which was filed on May 29, 2002. The prior application is incorporated herein by this reference.

### BACKGROUND

Adhesives for bonding lignocellulosic materials are known. Lignocellulosic materials are those that contain both lignin and cellulose, which include wood, wood agricultural crops (e.g., jute and kenaf), agricultural residues (e.g., bagasse and corn stalks), grasses and other plant substances.

Of particular interest are adhesives for the bonding of lignocellulosic materials such as wood and wood composite products. Conventional adhesives in the production of such lingocellulosic composite products are liquids of about 100-2500 cp (centipoise) viscosity at room temperature (about 25° C.) and roughly 40-55% resin solids content by weight. These conventional adhesives are formaldehyde polymers such as phenol formaldehyde (PF), urea formaldehyde (UF), melamine formaldehyde (MF) or melamine urea formaldehyde (MUF). There is another common adhesive composition, diphenylmethane diisocyanate, commonly referred to as MDI, which has a low viscosity and is not a polymer of formaldehyde.

Conventional adhesives used in the production of plywood, laminated veneer lumber (LVL), oriented strand board (OSB), particleboard, fiberboard, cellulosic materials and other substrates are applied to the substrate's surface by spraying, curtain coating, roll spreading, foam extrusion, spinning disc operations, and other processes. Small amounts of adhesive must be distributed over large surface areas for efficiency. In the OSB industry, PF and MDI resins are primarily used, because they form water resistant bonds.

Conventionally, the guiding principles for the preparation of a liquid plywood adhesive are (1) to maintain resin solids in the adhesive mix as high as possible, e.g., at 30-40% by weight, (2) to incorporate cellulosic fiber, such as nut shell flour, in a ratio of about 20-40% of the PF solids, and (3) to add only enough water as is necessary to lower the viscosity of the resulting composition to 1500-2000 cp, which is within the operating range of conventional glue handling equipment. Alternatively, some conventional adhesives are made with about 10-20% by weight wheat flour instead of the nut shell flour. The resulting higher viscosity liquid adhesives are applied over veneer surfaces by roller spreading, high pressure spraying, curtain coating, foam extrusion or liquid extension.

PF and MDI adhesives are both available in a liquid state or a solid state, i.e., as a powder. In the engineered panel industry, PF and UF resins are modified to have higher viscosities when necessary by admixing small amounts of fillers and extenders (about 2-10% by weight) or foaming agents. Today, these higher viscosities range from about 100 cp to about 15,000 cp. Higher viscosities help keep the adhesive on the panel surfaces where the adhesive properties are needed, and thus are more economical than low viscosity adhesives. If viscosity is increased too high, however, conventional adhesives application methods and apparatus cannot be used effectively.

A process for converting liquid PF and liquid MDI to powders has been developed. Liquid PF is converted to a powder by flash drying it. Liquid MDI is converted to a powder by filling it with sugars and/or starches. Efficiency of foamed PF, powder PF and powder MDI is about 25-30% higher than that of liquid resin formulations on the basis of the mass of adhesive per unit surface area, but these modifications have not found general acceptance for several reasons.

Foam PF adhesive is generally better than any other plywood adhesive glue compositions, but it requires special veneer handling equipment which is expensive and does exhibit “bleed through” in the surface cracks of the sheets. Under some conditions, foam PF adhesive reverts back to a low viscosity state. Powder PF has a significant deficiency because some of its particles are too small. These small particles tend to sink into the crevices and voids without contributing to bonding. Also, powder PF is not tacky and does not produce a good pre-press bond. The powder PF particles do not attach well a to wood surface, which creates possible health and environmental problems when particles fail to bond or are become detached.

Powder MDI is difficult to distribute because it tends to form aggregates (“clumps”). As a result, a process such as rubbing in the blender is necessary to disintegrate clumps into smaller particles. The lack of tack in powder PF and powder MDI decreases the amount of applicable powder adhesive—the maximum for powder PF is about 3% by weight and the maximum for powder MDI is about 4% by weight, which is not enough for many specialty products.

Attempts to produce powder UF and powder MF by flash drying or filling with extenders have not been successful. These resins are too reactive for flash drying, and filling them with extenders produces agglomerated compositions that are difficult to disintegrate into fine particles.

Consequently, conventional applications for bonding wood products rely chiefly on liquid adhesives having a low viscosity because such adhesives can be effectively reduced into small droplets and applied to surfaces to be bonded. High viscosity liquid adhesives are not used because there is no accurate and reliable way to reduce them into small droplets or particles and apply them to the surfaces to be bonded.

Conventional liquid adhesives are excessively absorbed by wood, so some of the adhesive applied to a surface is not used in bonding, and thus is in effect wasted. Powder adhesives do not attach well to wood and can be applied only at low rates compared to liquid adhesives, which decreases efficient throughput.

It would be desirable to develop new adhesive compositions and methods of applying them to solid lignocellulosic materials that overcome these disadvantages.

### SUMMARY

Described below are adhesive compositions and methods of making adhesives that address disadvantages of conventional adhesives for bonding lignocellulosic materials. Also described are methods of bonding lignocellulosic materials using the new adhesive compositions and associated apparatus for applying the new adhesives. Additionally, articles made of solid lignocellulosic materials and the new adhesives are described.

According to one aspect, an adhesive composition includes a conventional liquid adhesive and earth soil powder as an extender in predetermined quantities that result in desired characteristics for the adhesive. The conventional adhesive may be, e.g., a liquid phenol formaldehyde (PF). The adhesive composition may have a viscosity of at least about 25,000 centipoise.

The adhesive composition may comprise a phenol formaldehyde resin present in an amount of no more than about 30% of the composition by weight. More favorable results may be achieved with a phenol formaldehyde resin present in an amount of about 10% to about 25% of the composition by weight. Even more favorable results may be achieved with a phenol formaldehyde resin present in an amount of about 15% to about 20% of the composition by weight.

A ratio of adhesive resin by weight to soil powder by weight in the composition may range from about 0.3 to about 1.5.

The earth soil powder may comprise at least about 5% of the composition by weight. Favorable results are achieved with soil powder present in an amount of no more than about 75% by weight of the composition. More favorable results may be achieved with earth soil powder present in an amount of at least about 5% to about 50% of the composition by weight.

The adhesive composition may comprise about 55% by weight of soil powder mixed with about 10% to about 30% by weight of water to a homogeneous blend, to which about 12% to about 25% by weight of diphenylmethane diisocyanate (MDI) is blended in to produce the high viscosity adhesive.

The adhesive composition may also include a predetermined quantity of organic extender, such as industrial wheat flour, generally in an amount equal to or less than the amount of soil powder. Industrial wheat flour may be included in an amount of at least about 5% of the composition by weight. More favorable results may be achieved with industrial wheat flour present in an amount of at least about 5% to about 20% of the composition by weight.

According to another aspect, a method of extending liquid adhesives for bonding lignocellulosic materials includes providing liquid adhesive in a known quantity and adding a predetermined quantity of an inorganic extender to the liquid adhesive to form an extended adhesive. The inorganic extender may be, e.g., soil powder. The extended adhesive has a high viscosity. “High viscosity” as used herein is defined as a viscosity of at least about 25,000 cp, and is defined to include all measurable viscosities, as well as resulting adhesives that are nearly solid, which have a theoretically infinite viscosity. Stated differently, the resulting consistency of the extended adhesive may range from a high viscosity liquid, to an intermediate consistency that is paste- or gel-like, or even to a nearly solid consistency.

According to another aspect, an adhesive composition is formed from adding at least one extender to a conventional liquid adhesive such that the resulting composition has a high viscosity as defined herein. The extenders may be organic extenders, inorganic extenders or a combination of organic and inorganic extenders.

The extender may be a starch-containing material that undergoes gelatinization, and the adhesive may contain a greater amount of resin solids compared to the amount of extender solids. According to alternative formulations, the starch-containing material may not undergo gelatinization, and the adhesive may contain a greater amount of extender solids compared to resin solids.

More favorable results may be achieved when the adhesive composition has a viscosity of at least 30,000 cp. Even more favorable results may be achieved when the adhesive composition has a viscosity of at least 50,000 cp.

According to another aspect, a method of bonding lignocellulosic materials includes converting a “starting” adhesive to a high viscosity adhesive, disaggregating small particles from the high viscosity adhesive, applying the small particles in a desired quantity and distribution on surfaces that are to be bonded, and contacting the surfaces together at a sufficient pressure and temperature and over a sufficient duration to allow resin in the adhesive to solidify and the lignocellulosic material to bond.

According to another aspect, a starch-containing material, soil powder, water and a liquid starting adhesive are mixed together into a homogenous blend, and the resin solids in the liquid adhesive comprise about 12% to about 25% by weight of the blend and the starch-containing material and soil powder together comprise about 10% to about 40% by weight of the blend. More favorable results are achieved where the resin solids comprise about 15% to about 20% by weight of the blend.

The starch-containing material and the soil powder may together comprise about 30% to about 40% by weight.

The starting adhesive may include one or more of a phenolic (e.g., a phenol formaldehyde (PF)), an amine (e.g., a urea formaldehyde (UF), a melamine formaldehyde (MF), or a melamine urea formaldehyde (MUF)), or an isocyante (e.g., a diphenylmethane diisocyanate (MDI)) or a polyvinyl acetate (PVA).

According to another aspect, the starting adhesive is melamine urea formaldehyde, and converting the starting adhesive into the high viscosity adhesive includes blending together in a homogenous blend about 70% by weight of soil powder, about 30% by weight of melamine urea resin and sufficient water.

According to another aspect, about 50% to about 60% by weight of liquid melamine urea formaldehyde MUF) resin of about 50% solids content is blended to a homogenous blend with about 30% to about 60% by weight of soil powder to produce a MUF adhesive that contains about 10% to about 20% by weight of MUF solids, about 50% to about 75% by weight of soil powder and about 12% to about 25% by weight of water.

According to another aspect, the starting adhesive is urea formaldehyde; and converting the starting adhesive into the high viscosity adhesive includes blending together in a homogenous blend about 70% by weight of soil powder, about 30% by weight of urea formaldehyde resin and sufficient water.

According to another aspect, about 25% to about 50% by weight of liquid urea formaldehyde (UF) resin of about 50% by weight solids content is blended to a homogenous blend with about 50% to about 75% by weight of solid powder and about 12% about 25% by weight of water, and the adhesive composition contains about 12% to about 25% by weight UF solids, about 50% to about 75% by weight of soil powder and about 12% to about 25% by weight of water.

According to another aspect, the starting adhesive is liquid diphenylmethane diisocyanate (MDI) resin, and converting the starting adhesive to the high viscosity adhesive includes blending the liquid MDI resin with soil powder and water in the ratio of about 1 part by weight liquid MDI resin to about 3 parts by weight soil powder to about 1 part by weight of water.

According to another aspect, a method of making a high cohesive strength adhesive for bonding solid lignocellulosic materials includes combining or mixing a liquid adhesive with a starch-containing material to form an extended adhesive, and heating the extended adhesive to approximately boiling temperature for a predetermined duration sufficient to cause gelatinization of the starch-containing material and precondensation of resin in the liquid adhesive to obtain an extended adhesive having a high viscosity. The method may be carried out such that the gelatinization and precondensation occur substantially simultaneously. The adhesive includes may be a phenol formaldehyde, and the blend may be heated at approximately the boiling temperature for up to about 60 minutes.

According to another aspect, an apparatus for distributing high viscosity adhesive includes a separating roller having an outer surface with spaced protrusions. The separating roller is positionable adjacent a layer of the adhesive such that the protrusions contact the adhesive when the roller is rotated, thereby separating or disaggregating the particles and propelling the particles in a generally tangential direction towards the surfaces that are to be bonded. The apparatus may also include a rotating feed roller that feeds the adhesive to the separating roller, or a stationary feed tube with spaced holes through which the adhesive is extruded.

According to another aspect, a method for bonding together solid lignocellulosic materials includes applying a high viscosity adhesive to at least a first lignocellulosic substrate, the high viscosity adhesive having a viscosity of at least about 25,000 cp and comprising soil powder and at least one resin selected from phenolic resin, amine resin or isocyanate resin, and contacting the adhesive-applied first lignocellulosic substrate with at least one second lignocellulosic substrate under conditions sufficient for bonding together the first lignocellulosic substrate and the second lignocellulosic substrate.

According to another aspect, a bonded solid lignocellulosic article comprises at least two lignocellulosic substrates and an adhesive interposed between the two lignocellulosic substrates, the adhesive comprising soil powder and at least one resin selected from phenolic resin, amine resin or isocyanate resin and having a viscosity of at least about 25,000 cp.

According to another aspect, a method of extending liquid adhesives for bonding solid lignocellulosic materials comprises providing liquid adhesive in a known quantity, and adding a predetermined quantity of soil powder to the liquid adhesive to form an extended adhesive, the extended adhesive having a desired consistency ranging from a liquid consistency to a solid consistency determined according to the quantity of soil powder added to the liquid adhesive.

The new adhesives adhere well to wood and wood products, but penetrate only to a minimal surface depth, which can be controlled as desired. Also, the depth of penetration is not affected by elevated temperatures during pressing. The new adhesives have a bond strength for solid lignocellulosic materials that is comparable to or stronger than the bond strength of conventional liquid adhesives for those materials. The new adhesives are about 30-50% more effective than conventional liquid adhesives, which tend to over-penetrate the surfaces to be bonded.

High viscosity adhesives are not as readily absorbed by wood and the applied quantity stays on the surfaces for bonding. Such adhesives are transferable from surface to,. surface by contacting, smearing and rubbing, which contributes, e.g., in OSB and particle board, to better overall distribution of the resins within the adhesive composition. Such adhesives are tacky, which helps keep surfaces to be bonded together by compressing them without heat (e.g., during cold pre-pressing). Such adhesives tend not to have airborne particles and thus reduce dustiness and other airborne pollutants. Such adhesives can support higher concentrations or loading of adhesive resins than conventional liquid adhesives, if such higher bonding capability is desired.

### BRIEF DESCRIPTION OF DRAWINGS

FIG. 1 is a schematic cross sectional view in elevation of a first embodiment of an apparatus for applying the new adhesives.

FIG. 2 is a schematic cross sectional view in elevation of a second apparatus for applying the adhesives.

### DETAILED DESCRIPTION

Described below are adhesive compositions and methods of producing such compositions that address the disadvantages of conventional adhesives for bonding lignocellulosic materials. Also described are methods of bonding lignocellulosic materials using the new adhesive compositions, associated apparatus for applying the new adhesives and articles formed with the new adhesives.

A first type of new adhesive composition is formed by blending together under predetermined conditions an inorganic extender and a conventional liquid adhesive for bonding lignocellulosic materials, thereby extending the liquid adhesive. The extended adhesive has a high viscosity, which is defined herein to be a viscosity of at least about 25,000 cp. The resulting consistency of the extended adhesive may range from a high viscosity liquid, to an intermediate consistency that is paste- or gel-like, or even to a nearly solid consistency. Of particular interest are adhesives in which the inorganic extender is a soil powder. In addition to inorganic extenders such as soil powders, the second type of new adhesive can also include organic extenders, generally in an equal or lesser proportion to the inorganic extenders. Adhesives made with inorganic extenders such as soil powders are advantageous because (1) soil powders are relatively inexpensive and readily available, (2) soil powders absorb less adhesive than other extender materials, and (3) soil powders are inert and thus safer to store than other extender materials.

A second type of new adhesive compositions are compositions formed from blending together under predetermined conditions an organic extender, e.g., a starch-containing material, and a conventional liquid adhesive for bonding lignocellulosic materials. The resulting adhesives have a high viscosity as defined herein, which is in contrast to the much lower viscosity of the conventional liquid adhesives. The high viscosity adhesives are more efficient because more of the resin in the adhesive remains available at the surfaces for bonding, as opposed to the liquid adhesive in which some of the resins are effectively lost due to over-penetration.

The new adhesives are described as being of the first type or the second type only for the purpose of expository convenience. As described below, some new adhesives comprise both inorganic extenders and organic extenders, and thus have some properties of both the first type and the second type.

In general, only as much extender as is required to obtain the desired final consistency is used, which helps realize cost savings. Extenders may be in the form of powders, gels, emulsions and/or reactive liquids. Inorganic, nonabsorbent extenders of high specific gravity allow less resin to be used in produce a high viscosity adhesive than organic extenders, which tend to be more absorbent and of lower specific gravity.

### Properties of New Adhesive Compositions made with Inorganic Extender

According to the first type of new adhesive compositions, inorganic extenders such as soil powders are blended under predetermined conditions with conventional liquid adhesives. The resulting consistency may range from a high viscosity liquid, to a paste-like or gel-like consistency, or even to a solid consistency, depending upon the ratio of components.

For example, in the case of an adhesive made by blending approximately equal parts by weight of a PF liquid adhesive and soil powder, the resulting adhesive composition is a viscous liquid. At a ratio of about 1 part liquid PF adhesive to about 2 parts soil powder, the resulting adhesive is a high viscosity liquid. At a ratio of about 1 part liquid PF adhesive to about 3 parts soil powder, the resulting adhesive is a pliable solid. By selecting appropriate ratios, adhesive compositions of any desired high viscosity can be produced.

Soil is the surface layer of earth, composed of weathered mineral and rock fragments with decomposed vegetable and animal matter. Soil powders are derived from soil and are widely available. Raw soil is “processed” for sale as soil powder by removing large material (e.g., stones, sod, wood, debris, etc.) and decreasing the soil's moisture content. Clean, dry soil crumbles easily into soil powder.

Typically, soil providers in a locality will offer soil from at least the surrounding area. Sources of soil include virgin sources as well as reclamation of soil from landfills yard debris and displaced earth resulting from construction and mining projects.

The main components of most soil are lime, clay and sand. Table 1 shows the ranges of these components in different types of soils.

TABLE 1

| | Composition % | | |
|---|---|---|---|
| Soil Type | Sand | Clay | Lime |
| Flying sand | 80-100 | 0 | Poor |
| Loose sand | | 10 | 0-15 |
| Clay sand | | 20 | |
| Sandy loam | 30-50 | 30 | |
| Mild loam | | 40 | |
| Strong loam | | 55 | |
| Mild clay | 0-30 | 65 | |
| Common clay | | 75 | |
| Strong clay | | 90 | |
| Loamy soil | | 20-50 | Lime rich |
| Clay soil | 25-50 | 50-75 | 15-20 |
| Sandy soil | 0-25 | 50-75 | 15-60 |
| Calcareous soil | 90-80 | 50-75 | 50-75 |
| Lime soil | Little | 50-75 | 75-90 |

Representative particle sizes: coarse sand, 0.2-2.20 mm; fine sand, 0.02-0.2 mm; silt, 0.002-0.02 mm; and clay, less than 0.002 mm

Lime is calcium oxide. Clay formed of alumina silica and water, along with other minerals, and is a plastic substance-when moist. Sand is particles of disintegrated siliceous rock. The composition of soil is very variable. Sandy soil is said to contain about 40-80% of sand and about 15-20% of lime. Calcareous and lime soils are said to contain about 50-90% calcium or lime and very little of sand. Strong clay soil is said to contain about 0-15% of lime, about 0-30% of sand and about 90% of clay.

Soil composed mostly of lime and clay can be used as an extender of liquid adhesives. Soil containing significant portions of coarse sand (particle size of about 0.20 to 2.20 mm) may not be acceptable because it will result in excessive wear of cutting tools. In certain cases, it would be possible to screen coarse sand from a particular soil sample and use the remaining sample as an extender. A small proportion of fine sand (particle size of about 0.02 to 0.20 mm) would not cause a significant increase in cutting tool wear.

Clay, which is present in many types of soil, is a very good tack-producing agent. Clay-rich soil powder possesses the same capability as wheat flour and polysaccharide extenders in making adhesives tacky, which can be important in some applications. Clay is plastic, and is capable of intermixing well with and dispersing in liquids, and increases viscosity of conventional liquid adhesive solutions.

Soil powder has several significant advantages over polysaccharide powder, which is sometimes used as an extender. Soil powder particles are substantially incompressible, do not absorb adhesives, water or other liquids, and have a smooth surface that assists in their blending with liquid adhesives. It is much easier to blend liquid adhesives with soil powder than with polysaccharide powder, the particles of which are small, highly fibrilized and arranged in branched fibers of large surface area. Polysaccharides tend to strongly absorb and react with conventional liquid adhesives because polysaccharides have a cellular structure and contain hydroxyl groups. Any such reaction reduces the bonding potential of adhesives because less adhesive is left available for reacting with the substrate. Comparing particles of equal size, soil powder covered by a thin layer of adhesive solution produces more bonding than polysaccharide powder covered by equal amount of adhesive because of higher resin utilization.

Soil powder does not collapse during bonding. Soil powder particles tend to be harder than wood and similar materials, so when an adhesive containing soil powder is used to bond such materials and pressure is applied to improve the bonding, the soil particles will deform the surfaces of the material and become at least partially embedded therein, which serves as a kind of mechanical connection between the surfaces and increases the shear strength of the resulting bond. During such deformation, the adhesive is wiped off the surface of the particles and transferred to the surrounding surface of the material being bonded. Other extenders are generally not as hard as soil powder particles, and thus do not produce the same benefit.

Soil is available almost everywhere on earth surface in a compacted state as soft, pliable matter because it usually contains some water. After this water content is reduced, soil becomes harder and more brittle, which allows it to be easily crushed by relatively small pressure into a fine powder.

Soil powder is not ignitable or burnable and when suspended in air, and it does not form an explosive mixture as in the case of other materials, such as wheat flour, wood flour and other types of flour.

Table 2 describes several exemplary adhesive compositions containing soil powder as an extender.

TABLE 2

| | | | | | | | | | Viscosity |
|---|---|---|---|---|---|---|---|---|---|
| | | | Organic | Inorganic | | Total | | | (centipoise) |
| | PF (45%) | PF Solids | Extender | Extender | Added | Water | PF Solids %/ | | (measured at |
| Adhesive | weight % | weight % | weight % | weight % | Water weight % | weight % | Extender % | Total | about 25° C.) |
| 1 | 33.33 | 15.00 | 0.00 | 40.30 | 26.40 | 44.73 | 0.37 | 100.03 | |
| 2 | 33.33 | 15.00 | 0.00 | 25.00 | 60.00 | 60.00 | 0.60 | | Above |
| | | | | | | | | | 2M |
| | | | | | | | | | (60 s) |
| 3 | 33.33 | 15.00 | 16.67 | 16.67 | 33.33 | 51.66 | 0.45 | 100.00 | |
| 4 | 33.33 | 15.00 | 7.50 | 7.50 | 51.50 | 69.83 | 1.00 | 99.83 | 39000 |
| | | | | | | | | | (30 s) |
| 5 | 40.00 | 18.00 | 7.50 | 7.50 | 45.00 | 67.00 | 1.20 | 100.00 | |
| 6 | 44.50 | 20.03 | 7.50 | 7.50 | 40.50 | 64.98 | 1.34 | 100.00 | |
| A | 90.70 | 40.82 | 2.15 | 0.00 | 55.50 | 55.50 | 18.98 | 98.47 | 100-600 |
| B | 76.90 | 34.61 | 4.60 | 10.89 | 42.30 | 49.90 | 2.23 | 100.00 | 1500-2500 |

For Adhesives 1-6, the inorganic extender is earth soil powder and the organic extender is industrial wheat flour. The Adhesive A is a conventional liquid PF adhesive used for bonding oriented strand board (OSB). The Adhesive B is a conventional liquid PF adhesive used for bonding plywood (the inorganic extender contained in Adhesive B is not earth soil powder). Adhesives A and B are included in the table for comparison relative to new Adhesives 1-6, and their compositions are adpted from A. Pizzi (ed.), Wood Adhesives, Chemistry and Technology (1983), pages 106-176.

### Exemplary Adhesives 1-3

### EXAMPLE 1

For Adhesive 1, 15% by weight of PF solids, 40.3% by weight of earth soil powder and 26.40% by weight of added water are blended to a homogenous blend at room temperature.

The proportion of PF solids in Adhesive 1, which is about 15%, is determined by multiplying the percentage by weight of the PF (45%) solution by its concentration. In other words, 33.33%×0.45 equals 15% PF solids by weight.

Thus, the 33.33% by weight of PF (45%) solution also contributes 18.33% by weight of water (33.33%−15%=18.33%). Therefore, the total water weight fraction for Adhesive 1 is the sum of the added water (26.40%) plus the water in the PF (45%) solution, or 44.73% by weight.

### EXAMPLE 2

For Adhesive 2, 15% by weight of PF solids, 25% by weight of earth soil powder and 60% by weight of added water are blended to a homogenous blend at room temperature, and then the blend is heated to effect precondensation or drying of the resin. Specifically, the blend was heated and kept at approximately boiling temperature for 40 minutes, followed by cooling it to room temperature. After 40 minutes, the blend was a low viscosity liquid, but changed to a high viscosity after it was cooled to room temperature.

As a result of the heating, some of the water in the solution is lost in the form of vapor, so the total water weight % is not shown in Table 2 for Adhesive 2.

A test of the viscosity of Adhesive 2 was conducted on a Brookfield® viscometer with a No. 7 (RV) spindle. At a test mix cycle duration of 60 seconds, the viscosity of Adhesive 2 measured above 2,000,000 cp.

### EXAMPLE 3

For Adhesive 3, 15% by weight of PF solids, 16.67% by weight of industrial wheat flour, 16.67% by weight of earth soil powder and 33.33% by weight of added water are blended together as in Example 1, without any heating.

### Exemplary Adhesives 4-6

For Adhesives 4-6, the process of making the adhesive includes heating that causes starch gelatinization, as well as resin precondensation.

Starch is produced by plants and is present in many materials that are readily available, including wheat, corn, potato, rice and tapioca, as well as other grains and vegetables.

Starch gelatinization refers to the process by which a suspension of a starch-containing material (e.g., industrial wheat flour) in water is heated to a high temperature, causing its crystallites to melt and, with an excess of water, to undergo profound irreversible swelling. As a point of reference, cooked starch has a paste-like consistency and the cooking process is accompanied by large increase of apparent viscosity, or cohesive strength.

When conventional liquid adhesives, such as phenolic resins like PF, in the resole or A stage, are heated to higher temperature, they become more viscous and eventually rubbery, depending on time. With continued heating, they reach the resitol, or B stage and they become insoluble in usual solvents, but they will flow under heat and pressure. Further heating causes further hardening until they reach the resit or C stage, when they become insoluble and infusible.

Normally, PF resin present in a solution where starch is undergoing gelatinization does not condense fast enough because of the presence of water. It has been found, however, that if a larger quantity of PF resin is blended with wheat flour and water and then heated to boiling temperature and allowed to cool to room temperature, both gelatinization and to some degree resin precondensation will occur. In this case, the resin precondensation is from the A stage to the B stage. At large quantities, the blend cools slowly and thus the PF resin is at a temperature close to boiling long enough to effect some resin precondensation. Thus, it possible to achieve substantially concurrent starch gelatinization and resin precondensation.

A blend of PF resin, wheat flower and water will not solidify when heated at approximately boiling temperature in less than about 25 minutes. Thus, in the absence of other factors, such a blend usually must be heated at least about 25 minutes to achieve concurrent starch gelatinization and resin precondensation. Heating and cooling times can be determined experimentally for the specific quantity of the blend involved. Large quantities of a blend cool slowly, and thus the resin stays at higher temperature for a longer time.

### EXAMPLE 4

For Adhesive 4, 15% by weight PF solids, 7.5% by weight of industrial wheat flour, 7.5% by weight of earth soil powder and 51.5% by weight of added water are combined together, heated to at or near the boiling temperature, maintained at that temperature for an extended time (at least 25 minutes), and then allowed to cool to room temperature, thereby effecting substantially concurrent starch gelatinization and resin precondensation.

Tests of the viscosity of Adhesive 4 were conducted on a Brookfield® viscometer with a No. 7 (RV) spindle. At a test mix cycle duration of 60 seconds, the viscosity of Adhesive 2 measured 39,000 centipoise.

### EXAMPLE 5

For Adhesive 5, 18% by weight of PF solids, 7.5% by weight of industrial wheat flour, 7.5% by weight of earth soil powder and 45% by weight of added water were blended together according to the starch gelatinization and resin precondensation process of Example 4.

### EXAMPLE 6

For Adhesive 6, 20.03% by weight of PF solids, 7.5% by weight of industrial wheat flour, 7.5% by weight of earth soil powder and 40.5% by weight of water were blended together according to the starch gelatinization and resin precondensation process of Example 4.

### New High Viscosity Adhesive Compositions

The second type of new adhesives are formed by blending together conventional liquid adhesive and an organic extender, e.g., wheat flour, and water, and have a high viscosity as defined herein.

By definition, a fluid is a material continuum that responds to a static shear stress with an irrecoverable flow. In contrast, a material in the solid state responds to a shear stress with a recoverable deformation. Some of the adhesive compositions described herein are nonfluids that generally do not flow in response to a shear stress at standard temperature and pressure.

The viscosity of a fluid is one measure of its resistance to flow, and, specifically, to shear or to angular deformation. In a so-called Newtonian fluid, viscosity does not vary with the rate of deformation. In a non-Newtonian fluid, however, viscosity varies with the rate of deformation. Examples of non-Newtonian fluids are printer's ink, pastes, paints, greases, and most suspensions in water, such as coal slurries and drilling muds.

As is well known, viscosity can be measured using a rotational viscometer, such as a Brookfield® viscometer. A rotational viscometer has a rotatable spindle driven through a torsional spring that can be immersed in a container filled with a sample of the substance to be tested. During operation, the viscometer senses the torque required to rotate the spindle at constant speed while immersed in the sample. The dynamic viscosity of the sample is proportional to the measured torque.

As presented in Table 2 (above) and Table 3 (below) and discussed in the examples, the viscosities for three of the new adhesives are 39,000 cp or higher, measured at room temperature. In fact, the measured viscosity for Adhesive 2 was above 2,000,000 cp. The measured viscosities are representative, and the viscosities for all of Adhesives 1-8 are at a high viscosity as defined herein.

Although the lowest measured viscosity is 39,000 cp, the desired properties of the high viscosity adhesives hold for viscosities of at least about 25,000 cp. Any predetermined desired viscosity within the defined high viscosity range, i.e., from about 25,000 cp to any greater viscosity, can be achieved by controlling the time and temperature of the blending procedure.

In the range of 25,000 cp, the adhesives are high viscosity liquids. At higher viscosities, the adhesives have an intermediate consistency tending toward a nonfluid state. At extremely high viscosities, the adhesives are nearly solid in consistency.

By comparison, the viscosities of the conventional liquid adhesives in Tables 2 and 3 are 100-600 centipoise for Adhesive A and 1500-2500 centipoise for Adhesive B. Thus, the new adhesives have much higher viscosities-by approximately a factor of ten--than the conventional liquid adhesives. Correspondingly, the new adhesives also exhibit high cohesive strength.

TABLE 3

| | | | | | | | | | Viscosity |
|---|---|---|---|---|---|---|---|---|---|
| | | | Organic | Inorganic | Added | Total | | | (centipoise) |
| | PF (45%) | PF Solids | Extender | Extender | Water | Water | PF Solids %/ | | (measured at |
| Adhesive | weight % | weight % | weight % | weight % | weight % | weight % | Extender % | Total | about 25° C.) |
| 7 | 33.33 | 15.00 | 33.33 | 0.00 | 33.33 | 51.66 | 0.45 | 99.99 | |
| 8 | 33.33 | 15.00 | 10.00 | 0.00 | 56.70 | 75.03 | 1.50 | 100.03 | 30000 |
| | | | | | | | | | (10 s) |
| A | 90.70 | 40.82 | 2.15 | 0.00 | 55.50 | 55.50 | 18.98 | 98.47 | 100-600 |
| B | 76.90 | 34.61 | 4.60 | 10.89 | 42.30 | 49.90 | 2.23 | 100.00 | 1500-2500 |

### EXAMPLE 7

For Adhesive 7, 33.33% by weight of PF (45%) solution, 33.33% by weight of industrial wheat flour and 33.33% by weight of added water are blended to a homogenous blend without heating. (Of the 33.33% by weight flour, 1.3% by weight is NaOH (50%), which is a caustic used only for the purpose of blending the flour and only in this example.) The resulting composition has a high viscosity.

### EXAMPLE 8

For Adhesive 3, 15% by weight of PF solids, 10% by weight of industrial wheat flower and 56.7% by weight of added water are blended together, heated to a boil, maintained at or near the boiling temperature for an extended period (at least about 25 minutes) and cooled back to room temperature to effect starch gelatinization, resulting in a tacky homogenous adhesive composition having a high viscosity.

Tests of the viscosity of Adhesive 8 were conducted on a Brookfield® viscometer with a No. 7 (RV) spindle. At a test mix cycle duration of 10 seconds, the viscosity of Adhesive 8 measured 30,000 cp.

### Results

From a comparison of the conventional liquid adhesives, Adhesives A and B, with new Adhesives 1-8, it can be seen that each of the new adhesives has a lower resin (in this case, PF solids) content than either of the conventional liquid adhesives. The PF solids content in Adhesives 1-4,7 and 8 is 15%, which is less than half the PF solids content in Adhesives A and B (40.82% and 34.61%, respectively).

Adhesives 1, 3 and 7 are made without gelatinization and pre-condensation. It can be seen that Adhesives 1, 3 and 7 have less than half of the PF solids content, less water and more extender than Adhesives A and B.

For Adhesive A, there are about 18.9 times more PF resin solids than extender solids. For Adhesive B, there are about 2.2 times more PF resin solids than extender solids. In new Adhesives 1-8, however, there are only from about 0.37 to about 1.5 times more PF resin solids than extender solids.

The total solids in the new adhesives, which includes resin solids and extender solids, are less than or comparable to the total solids in the conventional liquid adhesives. The total solids in the adhesives can be calculated by adding the amounts of PF solids, organic extender and inorganic extender. New Adhesives 1-8 have total solids ranging from 26-48%, whereas conventional Adhesives A and B have total solids ranging from about 44-50%.

The total weight from water in the new Adhesives 1-8 ranges from about 45-75%, whereas the total weight from water in conventional Adhesives A and B is from about 50-55%.

Compared to conventional liquid adhesives, the new adhesives have a higher viscosity, contain substantially less resin solids, comparable or greater amounts of water, and comparable to much greater amounts of extender. Chiefly because of the reduced amounts of resin solids, which are the most expensive component, the new adhesives offer a significant cost savings when compared to the conventional liquid adhesives, as discussed below. As also discussed below, the new adhesives have comparable or greater bonding strength, and thus can be substituted in conventional liquid adhesive applications without loss of performance.

### Cost Effectiveness

Conventional liquid Adhesives A and B are available in quantity at rates of about $0.15 to $0.17 per pound. The calculated cost per pound of new Adhesives 1-8 varies from about 42% to about 65% of the cost of Adhesives A and B.

Adhesives 4, 5 and 6 are made by a process that includes starch gelatinization and resin pre-condensation, which results in lesser quantities of extender being required as compared to Adhesives 1, 3 and 7. As a result, the cost of materials in producing Adhesives 4, 5 and 6 is about 19% lower than the cost of producing Adhesives 1, 3 and 7. Less extender is needed to produce an adhesive of equal consistency when starch is gelatinized and resin to some degree pre-condensed.

Adhesives 1, 2, 3 and 7 contain predominantly more extender than resin solids by weight.

At equal consistency, earth soil extender is by about 18.8% less expensive than starch extender in applications without gelatinization and pre-condensation. But this margin is reduced to 3.66% less for earth soil extender when compared to applications in which gelatinization and precondensation occur. Overall, it appears that the soil powder extender in PF resin is more economical than starch extender.

Earth soil extender is by about 29% less expensive than wheat flour. All formulations made by gelatinization are less expensive than those that are non-gelatinized. The cost of a precondensed blend of PF and soil powder, however, is only 6.2% lower than the cost of the same blend without precondensation.

High viscosity adhesives bond wood equally well when wet, for example at up to moisture content as high as 75% in the composition, or dry, at moisture content of nearly 0%, because the quantity of resin solids will be the same. Resin solids in the adhesive composition are interpenetrated or mixed with tacky extender to form a complex that is not absorbed by wood. If water in the composition evaporates, this complex remains and becomes more tacky.

After longer exposure to heat or contact with wood that absorbs water, water will be extracted from the adhesive/extender complex. The adhesive, however, will generally stay on the wood's surface and available for bonding. This feature allows a possibility of using hot adhesive or drying the adhesive on wood during spreading or in a blender that has been converted to the dual role of both a blender and a drier.

This provides for pressing boards using wet, semi-wet or dry adhesive, which would simplify and enhance the manufacturing process.

### Bond Strength Results

Conventionally, in typical plywood processing operations, pressing of the assembled and glued veneers takes place at temperatures above about 200° F. (e.g., from about 220 to about 360° F.), for about 0.2 to about 0.5 minutes per millimeter of thickness of the material being bonded, and under pressures of about 100 to about 500 lb/in².

New Adhesives 1-8 were used in making plywood for testing the bond strengths of the adhesives. Two samples for each new adhesive were prepared using three 6″×6″×⅛″ veneers of Douglas fir resulting in two glue lines. For the first of the two samples, a quantity of adhesive equivalent to 1 g of PF solids per square foot of veneer (PF (100%)ft² was applied. For the second of the two samples, a quantity of adhesive equivalent to 2 g PF (100%)/ft². The samples were applied to the veneers using a wire brush or spatula.

Significantly, it should be noted that the adhesive density of about 1 g PF(100%)ft² is only about 25% of the density of conventional liquid adhesive typically used to produce plywood commercially. Correspondingly, the adhesive density of about 2 g PF(100%)/ft² is only about 50% of the density of conventional liquid adhesive typically used to produce plywood commercially. Thus, all of the samples contained were bonded with adhesives containing substantially less resin solids if conventional liquid adhesives in typical concentrations were used.

The veneers were then assembled into 3-ply assemblies and cold prepressed. The assemblies were inspected to ensure that satisfactory bonding had taken place.

Each assembly was then cut in half to form two specimens for bond strength (“wood failure”) testing. The first half was tested “dry,” i.e., at room temperature. The second half was first subjected to a boil-dry-boil sequence during which it was boiled for 3 hours, dried for 2 hours, and then boiled for 3 hours. Each second half was then cooled in cold water.

Thereafter, each of the first and second halves was separated at one of its glue lines to determine wood failure, which is measured as a percentage of area of wood fiber adhering at the glue line following completion of a specified shear test. The value is expressed as an estimated percentage based on visual examination of the wood area remaining adhered to the fractured surface in the test area. Higher wood failure percentages give an indication that more wood than adhesive failed, i.e., the adhesive was stronger than the wood. Typically, an adhesive that results in at least 80% wood failure is considered satisfactory.

Table 4 summarizes these results.

TABLE 4

| | Wood Failure | | | |
|---|---|---|---|---|
| | Dry | | After Boil/Dry/Boil | |
| | PF (100%)/ft² | | PF (100%)/ft² | |
| Adhesive | About 1 g | About 2 g | About 1 g | About 2 g |
| 1 | 80% | 100% | 50% | 70% |
| 2 | 85% | 90% | 50% | 60% |
| 3 | 80% | 90% | 50% | 50% |
| 4 | 80% | 90% | 40% | 40% |
| 5 | 90% (1.2 g) | 100% (2.4 g) | 80% (1.2 g) | 90% (2.4 g) |
| 6 | 90% (1.33 g) | 100% (2.67 g) | 80% (1.33 g) | 90% (2.67 g) |
| 7 | 80% | 90% | 40% | 70% |
| 8 | 90% | 80% | 40% | 30% |

The results of Table 4 show that the new adhesives exhibit failure in the range from about 80% to about 100% following dry testing at both adhesive densities. Because these dry testing results are all at 80% wood failure or above, all of Adhesives 1-8 show satisfactory bonding based on this benchmark.

For the halves subjected to the boil-dry-boil sequence, the new adhesives have measured wood failure in the range from about 30% to about 90%, with Adhesives 5 and 6 showing the highest wood failure percentages. The spread in results can result from variations in the veneers and pressing, among other factors. The boil-dry-boil results for Adhesives 5 and 6 are all at about 80% or above, thus indicating that these adhesives meet the typical 80% wood failure benchmark.

Adhesives 5 and 6 contain more PF solids than Adhesives 1-4, 7 and 8. Adhesives 5 and 6 contain about 18% and 20% PF by weight, respectively, whereas Adhesives 1-4, 7 and 8 each contain about 15% PF by weight. Note that Table 4 shows the weights of adhesive applied to each sample for Adhesives 5 (about 1.2 g and 2.4 g) and 6 (about 1.33 g and 2.67 g), which are higher than the weights for Adhesives 1-4, 7 and 8 (about 1 g and 2 g).

Although the boil-dry-boil results for Adhesives 1-4, 7 and 8 are below the typical minimum 80% wood failure benchmark, these results still show that the adhesives form adequate bonds with much less resin than conventional liquid plywood adhesives.

Further, by comparison of Adhesives 5 and 6 with Adhesives 1-4, 7 and 8, the results show that with small additional quantities of resin, i.e., by increasing the amount of PF solids above 15%, Adhesives 1-4, 7 and 8 would be expected to meet the 80% wood failure benchmark.

Overall, the results show that the new adhesives achieve bonding with as little as 25% of the resin solids used in conventional liquid adhesives, and that comparable bond strengths with the new adhesives can be achieved with substantially less resin than is used in conventional liquid adhesives. New adhesives with even about 45-50% less resin than conventional adhesives would appear to achieve comparable bond strengths.

### Application of New Adhesives

Some of the new adhesives cannot be effectively applied using conventional liquid adhesive methods such as spraying, roller spreading, curtain coating, application by spinning discs or extrusion, chiefly because these new adhesives are much more viscous than the conventional liquid adhesives. Stated differently, some of the new adhesives have a much higher cohesive strength that requires higher forces to disaggregate them into small particles.

The application of adhesive over large surface areas, such as in the production of oriented strand boards or plywood, requires that the adhesive is first disaggregated into small particles and then uniformly distributed according to a predetermined density over the surfaces to be bonded. In known applications, the adhesive particle size may be about 50-100 microns in diameter on average. If such a distribution cannot be achieved, too much adhesive is applied, which increases costs.

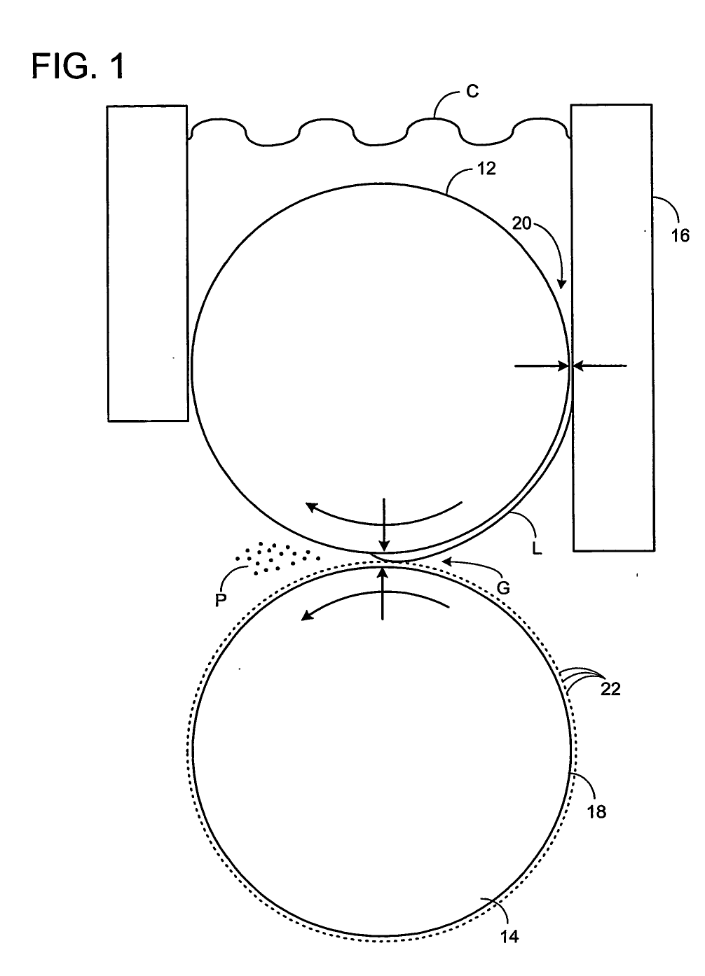

Advantageously, it is possible to separate by force individual particles of the desired size from the bulk of the adhesive and distribute them directly on the surfaces to be bonded with a minimal number of steps and apparatus. According to one embodiment, an adhesive distributor 10 as illustrated schematically in FIG. 1 includes an assembly of two rollers 12, 14 rotatably driven to rotate in opposite directions with their circumferential surfaces separated from each other by a selectively controllable gap G. Although the rollers 12, 14 are shown as being of approximately equal size, they may also have different sizes.

The upper or feeding roller 12 is positioned near the bottom end of a container 16 in which adhesive C is stored. The bottom or separating roller 14 has a textured circumferential surface 18 sized and shaped to contact the adhesive on the roller 12 in the area adjacent the gap G. The adhesive C is blended, either at an earlier stage within the container 16 or at another location.

In operation, the rollers 12, 14 are rotated at high speeds, i.e., at about 3,000 RPM in one example. The rotation of the feeding roller 12 causes the adhesive C to be drawn onto its surface. Further rotation of the feeding roller 12 in the clockwise direction as shown causes the adhesive C on the surface of the roller 12 to be drawn out of the container 16 through an adjustable feeding gap 20 between the surface of the roller 12 and the container 16. In FIG. 1, the feeding gap 20 is shown at the lower right end of the container 16. As illustrated, the exiting adhesive C may have the form of a layer L on the surface of the feeding roller 12. In one embodiment, the layer L has a thickness of about ⅛″ at least in the area of the gap G.

The textured circumferential surface 18 of the roller 14 may be formed by spaced spikes 22 protruding from the circumferential surface. In one embodiment, the spikes 22 are spaced at approximately 1/16″ intervals. The spikes 22 are sized to engage the layer L on the feeding roller 12 and to penetrate to a depth of 2-200 microns, thereby grating or separating small particles P from the layer L and propelling them in a tangential direction through the action of the spikes towards a surface to be bonded (not shown).

The textured circumferential surface 18 may be produced by a machining operation, or by other means, such as attachment of a separate element or elements to the roller 14. The surface of the roller 12 may also be roughened either by machining or attachment of a separate element to assist in maintaining the adhesive in contact with the surface until subjected to the action of the roller 14.

In one embodiment, the rollers 12, 14 each have an 8-inch diameter. The roller 14 is rotated at about 3000 RPM. Thus, one complete rotation of the roller 14 is completed in 0.02 seconds, and any individual spike on the surface 18 is in contact with the layer L only for about 0.00005 seconds. As a result, any possible densification of the adhesive is prevented or at least reduced.

Particles of predetermined sizes, shapes and quantities can be produced by adapting the textured surface 18 (including, e.g., diameter, spike height and spacing) and the rotation rates of the rollers 12, 14. Better results are obtained if the adhesive is blended to a homogeneous blend prior to application, which allows the layer L to be formed of a more uniform thickness.

Because the adhesive is viscous, it does not tend to “leak” from the container 16. Also, the operation can be controlled such that the roller 12 is essentially “clean” after the layer L is contacted by the spikes 22.

As one example, one embodiment of the roller 12 having a length of 12 inches, a diameter of 8 inches and a 1/16-inch spike spacing rotated can be rotated at such speed to separate 50-100 micron particles from the adhesive at a rate of about 232 particles per minute, which can be considered a theoretical minimum. It is contemplated, of course, that the output in any particular embodiment will be controlled by setting the rotation speed, roller diameter, spike size and spike spacing.

### APPARATUS EXAMPLE

The distributor of FIG. 1 has been examined on a laboratory prototype equipped with an 8-inch diameter separating roller having a length of about 12 inches, and a 4-inch diameter feeding roller.

A series of tests in distributing adhesive on OSB strands or veneers, using a new adhesive containing soil powder extender and, in this case, MDI resins. Specifically, the adhesive contained about 1 part MDI resins to about 2 parts soil powder.

Conventionally, MDI content in common OSB boards is around 2% of the board weight. Calculations show that at this MDI content, there is 1.236 grams of MDI per square foot, assuming average strand thickness of about 0.028 inch and a board density of 40 lb/ft³.

The prototype distributor was operated to disaggregate the adhesive into small particles and propel them onto 1 ft² veneers. Table 5 presents the results of examining five random 1 in² areas and weighing the amount of adhesive applied.

TABLE 5

| | Total, | MDI, | SP, | Number of |
|---|---|---|---|---|
| Sample Area | grams | grams | Grams | Particles |
| 1 | 5.0 | 1.25 | 3.750 | 128 |
| 2 | 3.417 | 0.854 | 2.530 | 88 |
| 3 | 3.617 | 0.904 | 2.713 | 90 |
| 4 | 3.417 | 0.854 | 2.563 | 88 |
| 5 | 4.317 | 1.079 | 2.538 | 96 |

In addition to the weight of adhesive in each sample area, the numbers of particles present in the areas were counted. As shown in Table 5, the number of particles ranged from a high of 128 for Sample Area 1 to a low of 88 for Sample Areas 2 and 4, with the average number of particles being 100.

From inspection, it appeared that the density of particles applied with the prototype distributor was higher than the number of droplets of adhesive on a typical industrial OSB board produced in a conventional manner.

In contrast to the particles of adhesive, however, droplets of relatively low viscosity conventional liquid adhesive become absorbed almost immediately upon application to the surfaces.

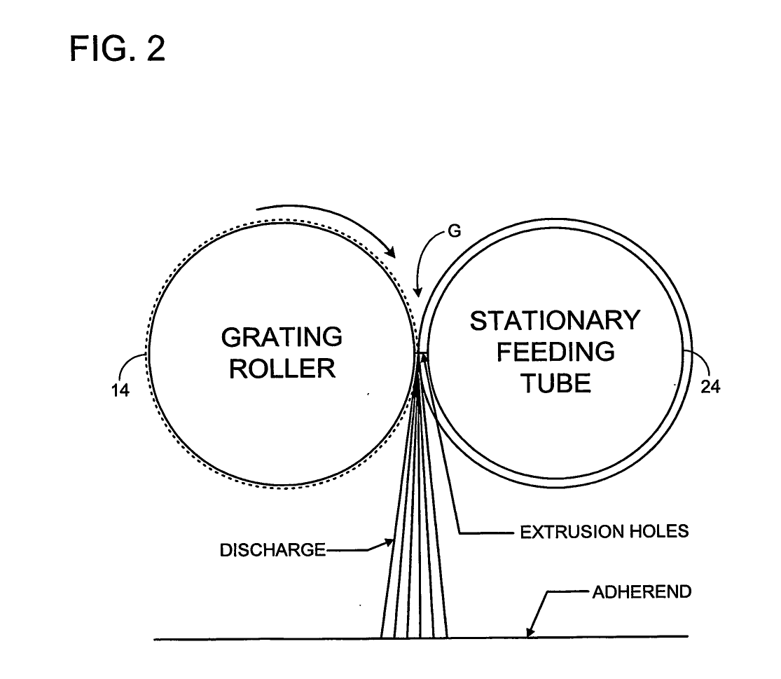

FIG. 2 is a schematic depiction showing another embodiment of a distributor. In the embodiment of FIG. 2, only the grating roller 14 rotates, and there is a stationary feeding tube 24 that contains and feeds the adhesive, instead of the feeding roller 12 and container 16 of the FIG. 1 embodiment.

Adhesive within the feeding tube 24 is forced out through extrusion holes located along the tube by a pneumatic or other source of pressure at a predetermined rate at the gap G. The separating or grating roller 14 contacts the exiting adhesive, disaggregates it into small particles and propels the particles in a tangential direction towards an adherend, i.e., a surface to be bonded.

The application processes described above can be carried out without temperature modification, i.e., at the temperature of the production facility. In some circumstances, it may be advantageous to heat the blended adhesive before and/or during application. The application of adhesive at a higher temperature than the surfaces to be bonded may be beneficial, e.g., to assist in lowering moisture content in the materials to be bonded to increase the effectiveness of the bond.

The adhesives, methods of bonding and apparatus for applying the adhesive described herein are applicable to lignocellulosic materials, including but not limited to wood, wood products and wood composite products, which of course include engineered wood products such as engineered panels and products made from such panels (including fiberboard, particleboard, plywood, cellulosic substrates, OSB, LVL, Sonoboard®, etc.).

Although the above examples describe new phenol formaldehyde and MDI adhesives, those of ordinary skill in the art would understand that the same principles can be applied to produce new adhesives from urea formaldehyde, melamine formaldehyde, melamine urea formaldehyde, resorcinol formaldehyde, ketone aldehyde resins, polyvinyl acetate, copolymers of vinyl acetate and ethylene, and isocyanates as well as other similar adhesives.

While the invention has been disclosed in this patent application by reference to the details of some preferred embodiments of the invention, it is to be understood that this disclosure is intended in an illustrative rather than in a limiting sense, as it is contemplated that modifications will readily occur to those skilled in the art within the spirit of the invention and the scope of the following claims.

1. An adhesive composition for bonding solid lignocellulosic materials comprising a liquid adhesive for solid lignocellulosic materials blended together with at least one extender under predetermined conditions to achieve a viscosity of at least about 25,000 cp.

2. A method of extending liquid adhesives for bonding solid lignocellulosic materials comprising:
providing liquid adhesive in a known quantity;
adding a predetermined quantity of soil powder to the liquid adhesive to form an extended adhesive, the extended adhesive having a viscosity of at least about 25,000 cp.

3. A method of making a high cohesive strength adhesive for bonding solid lignocellulosic materials comprising:
mixing a liquid adhesive with a starch-containing material to form an extended adhesive;
heating the extended adhesive to approximately boiling temperature for a duration sufficient to cause substantially concurrent gelatinization of the starch-containing material and precondensation of resin in the liquid adhesive to obtain an extended adhesive having a viscosity of at least about 25,000 cp.

4. A method of bonding solid lignocellulosic materials comprising:
converting a starting adhesive to a high viscosity adhesive having a viscosity of at least about 25,000 cp, the starting adhesive being comprised of at least one of a liquid adhesive, a foam adhesive and a powder adhesive;
disaggregating small particles from the high viscosity adhesive;
applying the small particles in a desired quantity and distribution on surfaces of solid lignocellulosic material that are to be bonded; and
pressing the surfaces together at a sufficient pressure and temperature and over a sufficient duration to allow resin in the adhesive to solidify and the lignocellulosic material to bond.

5. The method of claim 4 wherein the pressing includes pressing the surfaces together for about 0.2 minutes to about 0.5 minutes per millimeter of thickness of the lignocellulosic material.

6. The method of claim 4 wherein the pressing includes pressing the surfaces together at a pressure of about 100 lb/in² to about 500 lb/in².

7. The method of claim 4 wherein the pressing includes pressing the surfaces together at temperatures of at least 200° F.

8. The method of claim 4, wherein the solid lignocellulosic materials being bonded are part of an engineered panel selected from at least one of plywood, particleboard, fiberboard, oriented strand board, cellulosic panels, laminated veneer lumber, papers and cardboards.

9. The method of claim 4 wherein the starting adhesive is a liquid adhesive, and converting of the starting adhesive to a high viscosity adhesive includes extending the liquid adhesive by mixing with predetermined quantities of an extender and water.

10. The method of claim 9 wherein the extender is a starch-containing material selected from at least one of grain flours and vegetable flours.

11. The method of claim 9, wherein the extender is a starch-containing material selected from at least one of wheat flour, rye flour, tapioca flour, rice flour, soy flour, corn flour, and potato flour.

12. The method of claim 9 wherein the extender is a starch-containing material that undergoes gelatinization, wherein the adhesive contains resin solids, and wherein the adhesive contains a greater amount of resin solids compared to the amount of extender solids.

13. The method of claim 10 wherein the starch-containing material does not undergo gelatinization, wherein the adhesive contains resin solids, and wherein the adhesive contains a greater amount of extender solids compared to resin solids.

14. The method of claim 4 wherein the extender comprises a soil powder and a starch-containing material.

15. The method of claim 9 wherein the extender comprises a soil powder comprising at least one of lime, clay and sand.

16. The method of claim 9 wherein the extender comprises a soil powder obtained from at least one of a mild clay soil and a lime-rich soil.

17. The method of claim 10 wherein the extender is a mixture of the starch-containing material and a soil-based extender.

18. The method of claim 4 wherein the starting adhesive is a liquid adhesive and the converting of the starting adhesive to a high viscosity adhesive includes blending together a starch-containing material, soil powder, water and the liquid adhesive into a homogenous blend, and wherein resin solids in the liquid adhesive comprise about 12% to about 25% by weight of the blend and the starch-containing material and soil powder together comprise about 10% to about 40% by weight of the blend.

19. The method of claim 18 wherein the resin solids comprise about 15% to about 20% by weight of the blend.

20. The method of claim 18 wherein the starch-containing material and the soil powder together comprise about 30% to about 40% by weight.

21. The method of claim 18 wherein the starting adhesive may include one or more of a phenol formaldehyde (PF), a urea formaldehyde (UF), a melamine formaldehyde (MF), a melamine urea formaldehyde (MUF), a diphenylmethane diisocyanate (MDI) or a polyvinyl acetate (PVA).

22. The method of claim 4 wherein the starting adhesive is a liquid adhesive and converting the starting adhesive to a high viscosity adhesive includes blending together a starch-containing extender and the liquid adhesive into a homogenous blend, heating the blend to approximately boiling temperature and cooling the blend to room temperature to effect substantially concurrent starch gelatinization and resin precondensation.

23. The method of claim 22 wherein the liquid adhesive includes phenol formaldehyde and blend is heated at approximately the boiling temperature for up to about 60 minutes.

24. The method of claim 9 wherein the extender is a soil powder, and the high viscosity adhesive is produced by blending together the soil powder, a phenol formaldehyde starting adhesive and water without requiring heating or other treatment.

25. The method of claim 4 wherein the starting adhesive is a liquid adhesive and converting the starting adhesive to a high viscosity adhesive comprises:
blending together in a homogenous mixture about 15% by weight of phenol formaldehyde resin solids, about 25% by weight of soil powder and about 60% by weight of water;
heating the mixture to approximately boiling temperature;
maintaining the mixture at approximately boiling temperature for about 40 minutes; and
slowly cooling the mixture, thereby producing the high viscosity adhesive by resin precondensation without starch gelatinization.

26. The method of claim 4 wherein the starting adhesive is melamine urea formaldehyde, and converting the starting adhesive into the high viscosity adhesive includes blending together in a homogenous blend about 70% by weight of soil powder, about 30% by weight of melamine urea resin and sufficient water.

27. The method of claim 4 wherein the starting adhesive is urea formaldehyde, and converting the starting adhesive into the high viscosity adhesive includes blending together in a homogenous blend about 70% by weight of soil powder, about 30% by weight of urea formaldehyde resin and sufficient water.

28. The method of claim 4 wherein the starting adhesive is liquid diphenylmethane diisocyanate (MDI) resin, and converting the starting adhesive to the high viscosity adhesive includes blending the liquid MDI resin with soil powder and water in the ratio of about 1 part by weight liquid MDI resin to about 3 parts by weight soil powder to about 1 part by weight of water.

29. The method of claim 4 wherein the solid lignocellulosic material is wood and the starting adhesive is a liquid adhesive, and wherein the starting adhesive is converted to the high viscosity adhesive by chemical, physical or mechanical methods.

30. The method of claim 4 wherein about 15% to about 20% by weight of powder phenol formaldehyde resin, about 15% by weight of wheat flour and about 60% to about 70% by weight of water are blended into a homogenous high viscosity adhesive.

31. The method of claim 4 wherein disaggregating the particles from the high viscosity adhesive includes heating the adhesive, thereby decreasing the time required to press the surfaces.

32. The method of claim 4 wherein disaggregating the particles from the high viscosity adhesive involves use of a mechanical separation process.

33. The method of claim 4 wherein disaggregating the particles from the high viscosity adhesive includes contacting a layer of the adhesive with protrusions on a rotating distributor, thereby separating particles of the adhesive and propelling the particles in a generally tangential direction towards the surfaces to be bonded.

34. The method of claim 4 wherein the high viscosity adhesive has a viscosity of at least 30,000 cp.

35. The method of claim 4 wherein the high viscosity adhesive has a viscosity of at least 50,000 cp.

36. An apparatus for distributing high viscosity adhesive comprising a roller having an outer surface with spaced protrusions, the roller being positionable adjacent a layer of the high viscosity adhesive such that the protrusions contact the adhesive when the roller is rotated, thereby disaggregating the particles and propelling the particles in a generally tangential direction towards the surfaces that are to be bonded.

37. The apparatus of claim 36, further comprising a uniform feed roller on which the high viscosity adhesive is fed at a substantially uniform rate, the uniform feed roller being separated from the rotary grater by a controllable gap.

38. The apparatus of claim 36, further comprising a stationary feed tube that stores adhesive and is selectively controllable to provide the layer of adhesive through at least one opening formed in the tube.

39. A method of bonding solid lingocellulosic materials, which comprises:
extending a liquid adhesive by adding water and a soil powder comprising lime and clay, in quantities that would produce an adhesive composition having a high viscosity;
disaggregating the adhesive composition into particles;
applying the particles to surfaces of solid lingocellulosic material that are to be bonded; and
pressing the surfaces together at temperatures of about 220° F. to about 360° F. for about 0.2 minutes to about 0.5 minutes per one millimeter of the thickness of the lignocellulosic material to solidify resins in the adhesive and thereby bond the lignocellulosic material.

40. The method of claim 39 wherein about 55% by weight of soil powder is blended with about 10% to about 30% by weight of water to a homogeneous blend to which about 12% to about 25% by weight of diphenylmethane diisocyanate (MDI) is blended in to produce the high viscosity adhesive.

41. The method of claim 39 wherein about 24% to about 50% by weight of about 50% solids content liquid phenol formaldehyde resin, about 50% by weight soil powder and about 12% to about 25% by weight of water are blended to a homogenous blend that contains about 12% to about 25% by weight of PF solids, about 50% to about 75% by weight of soil powder and about 12% to about 25% by weight of water.

42. The method of claim 39 wherein about 50% to about 60% by weight of liquid melamine urea formaldehyde (MUF) resin of about 50% solids content is blended to a homogenous blend with about 30% to about 60% by weight of soil powder to produce a MUF adhesive that contains about 10% to about 20% by weight of MUF solids, about 50% to about 75% by weight of soil powder and about 12% to about 25% by weight of water.

43. The method of claim 39 wherein about 25% to about 50% by weight of liquid urea formaldehyde (UF) resin of about 50% by weight solids content is blended to a homogenous blend with about 50% to about 75% by weight of solid powder and about 12% about 25% by weight of water, and the adhesive composition contains about 12% to about 25% by weight UF solids, about 50% to about 75% by weight of soil powder and about 12% to about 25% by weight of water.

44. The method of claim 39 wherein liquid adhesive is blended to a homogenous blend with a mixture of soil powder and starch-containing material to produce an adhesive composition having a nonfluid consistency.

45. A method of bonding solid lignocellulosic materials which comprises:
mixing one or more of phenol formaldehyde, melamine formaldehyde, urea formaldehyde, diphenylmethane diisocyanate, and polyvinyl acetate liquid adhesives with a starch-containing material to form a blend;
maintaining the blend at a high temperature for a sufficient time to convert the blend to a high viscosity adhesive by gelatinization and precondensation;
disaggregating the high viscosity adhesive into small particles and depositing the particles on surfaces of solid lignocellulosic material that are to be bonded in a desired quantity and distribution; and
pressing the surfaces together at a temperature of about 220° F. to about 360° F. and for a duration of about 0.2 minutes to about 0.5 minutes per one millimeter thickness of the surfaces.

46. The method of claim 45 wherein the pressing includes pressing the surfaces together at a pressure of about 100 lb/in² to about 500 lb/in².

47. The method of claim 45 wherein about 30% to about 50% by weight of the liquid adhesive is mixed with a starch-containing material or a blend of a starch-containing material and soil powder and about 60% to about 75% by weight of water, and the blend is heated to approximately boiling temperature and let cool to room temperature at such a speed that the blend is converted to high viscosity adhesive.

48. The method of claim 45 wherein about 30% to about 50% by weight of the liquid adhesive is mixed with starch-containing material or a blend of starch-containing material and soil powder and about 60% to about 75% by weight of water, the blend is heated to approximately boiling temperature and maintained near the boiling temperature for a predetermined duration.

49. An adhesive composition for bonding solid lignocellulosic materials comprising a liquid adhesive and soil powder blended together so as to have a nonfluid consistency.

50. An adhesive composition comprising a solution of at least adhesive resin, water and earth soil powder having a viscosity of at least 25,000 cp.

51. The adhesive composition of claim 50 wherein the adhesive resin comprises a phenol formaldehyde resin.

52. The adhesive composition of claim 50 wherein the adhesive resin comprises a phenol formaldehyde resin and is present in an amount of about 10% to about 25% of the composition by weight.

53. The adhesive composition of claim 50 wherein the adhesive resin comprises a phenol formaldehyde resin and is present in an amount of about 15% to about 20% of the composition by weight.

54. The adhesive composition of claim 50 wherein the earth soil powder comprises at least about 5% of the composition by weight.

55. The adhesive composition of claim 50 wherein the earth soil powder comprises at least about 5% to about 45% of the composition by weight.

56. The adhesive composition of claim 50 further comprising industrial wheat flour in an amount of at least about 5% of the composition by weight.

57. The adhesive composition of claim 50 further comprising industrial wheat flour in an amount of about 5% to about 20% of the composition by weight.

58. The adhesive composition of claim 54 further comprising industrial wheat flour in an amount of about 5% of the composition by weight.

59. The adhesive composition of claim 50, wherein the adhesive resin comprises no more than about 30% of the composition by weight.

60. The adhesive composition of claim 50 wherein the adhesive resin component comprises about 10% to about 25% of the composition by weight.

61. The adhesive composition of claim 50 wherein a ratio of adhesive resin by weight to soil powder by weight ranges from about 0.3 to about 1.5.

62. The adhesive composition of claim 50 having a viscosity of at least about 25,000 cp.

63. A method for bonding together solid lignocellulosic materials, comprising:
applying a high viscosity adhesive to at least a first lignocellulosic substrate, the high viscosity adhesive having a viscosity of at least about 25,000 cp and comprising soil powder and at least one resin selected from phenolic resin, amine resin or isocyanate resin; and
contacting the adhesive-applied first lignocellulosic substrate with at least one second lignocellulosic substrate under conditions sufficient for bonding together the first lignocellulosic substrate and the second lignocellulosic substrate.

64. A bonded solid lignocellulosic article, comprising:
at least two lignocellulosic substrates; and
an adhesive interposed between the two lignocellulosic substrates, the adhesive comprising soil powder and at least one resin selected from phenolic resin, amine resin or isocyanate resin and having a viscosity of at least about 25,000 cp.

65. A method of extending liquid adhesives for bonding solid lignocellulosic materials comprising:
providing liquid adhesive in a known quantity;
adding a predetermined quantity of soil powder to the liquid adhesive to form an extended adhesive, the extended adhesive having a desired consistency ranging from a liquid consistency to a solid consistency determined according to the quantity of soil powder added to the liquid adhesive.
